(19) United States
(12) Patent Application Publication
(10) Pub. No.: US 2020/0262955 A1
(43) Pub. Date: Aug. 20, 2020

(54) Isosorbide derivatives as reactive additives in reactive resins and chemical dowels

(71) Applicant: Hilti Aktiengesellschaft, Schaan (LI)

(72) Inventors: Jens Bunzen, Augsburg (DE); Thomas Bürgel, Landsberg (DE); Beate Gnass, Gersthofen (DE); Gerald Gaefke, Augsburg (DE); Klaus Jaehnichen, Dresden (DE); Brigitte Voit, Dresden (DE)

(73) Assignee: Hilti Aktiengesellschaft, Schaan (LI)

(21) Appl. No.: 15/733,026

(22) PCT Filed: Nov. 15, 2018
(86) PCT No.: PCT/EP2018/081440

§ 371 Date: Apr. 22, 2020

(30) Foreign Application Priority Data
Nov. 28, 2017 (EP) 17204039.6

(51) Int. Cl. C08F 222/10; C04B 40/06; C04B 26/16

(52) U.S. Cl. CPC C08F 222/1065; C04B 40/0666; C04B 2111/00715; C08F 2800/10; C04B 26/16

(57) ABSTRACT

A reactive resin includes a vinyl ester resin based on renewable raw materials, in particular a dianhydrohexitol-based vinyl ester resin as the base resin. A reactive resin component containing this reactive resin is useful for chemical fastening.

The present invention relates to a reactive resin comprising a vinyl ester resin based on renewable raw materials, in particular a dianhydrohexitol-based vinyl ester resin as the base resin, to a reactive resin component containing this reactive resin, and to the use thereof for chemical fastening.

The use of chemical fastening agents based on radically curable reactive resins has long been known. In the field of fastening technology, the use of resins as an organic binder for chemical fixing technology, for example as a dowel mass, has become accepted. These are composite materials which are packaged as multicomponent systems, one component (the reactive resin component) containing the reactive resin and the other component (the hardener component) containing the curing agent. Other common constituents such as fillers, accelerators, stabilizers, solvents, and reactive diluents may be contained in one and/or the other component. By mixing the two components, the curing reaction, i.e. the polymerization, is initiated by radical formation and the resin is cured to obtain duromers.

Vinyl ester resins and in particular vinyl ester urethane resins are usually used as base resins in conventional reactive resins and reactive resin components, said vinyl ester resins and vinyl ester urethane resins being obtainable by reaction of monomeric or polymeric aromatic diisocyanates and hydroxy-substituted methacrylates, such as hydroxyalkyl methacrylate. EP 0 713 015 B1, for example, describes dowel compositions comprising unsaturated polyester resins, vinyl ester resins, including vinyl ester urethane resins, as base resins. DE 10 2011 017 626 B4 also describes vinyl ester urethane resins. The raw materials for the base resins in such systems come from classic petroleum chemistry, in which the raw materials are obtained from fossil raw material sources, such as petroleum.

It is common knowledge that fossil raw materials such as petroleum are not inexhaustible and will eventually dry up. In the event that the availability of fossil raw material sources decreases, there is a risk that the compounds that are essential for the high demands placed on the chemical fastening systems may no longer be available.

Therefore, there will be a future need for alternative systems based on renewable raw materials with a high proportion of carbon from renewable raw materials in order to be able to continue to provide highly specialized chemical fastening systems.

An object of the invention is therefore to provide a reactive resin for chemical fastening technology, the resin component of which contains a base resin and optionally other constituents, such as reactive diluents, which have a very high proportion of carbon from renewable raw materials.

DE 10 2014 103 923 A1 describes, for example, reactive resin components to which biogenic fillers such as flours of kernels or skins of known fruits (walnuts, cherries, olives), or of vegetable fibers, lignins, tannins, polysaccharides or sugar have been added to increase the biogenic content. However, the reactive components of the resin compositions described are based on fossil raw materials. There is therefore also a need for base resins and reactive diluents which are available from biogenic raw materials.

A class of biogenic monomer constituents for polymers that has recently attracted great scientific and technical interest is the dianhydrohexitols, and in particular isosorbide. The starting materials for these compounds are naturally occurring hexoses (for isosorbide, D-glucose, for example), which are hydrogenated to the corresponding alcohols and then cyclized twice using double dehydration. The dianhydrohexitols therefore have two secondary hydroxy groups, which make them a versatile platform chemical made from renewable raw materials.

Polymers are already known in which dianhydrohexitols are used as monomers either directly or after functionalization of the hydroxyl groups. DE 10 2012 219 476 describes an oligomeric dianhydrohexitol-based vinyl ester urethane resin which can be used in reactive resin components for chemical fastening.

However, the present invention was not only based on the concept of replacing, in whole or in part, components of multi-component reactive resin systems which come from fossil sources with sugars which have been functionalized with one or more (meth)acrylate group(s) in order to achieve a higher proportion of biogenic resins. The aim of the invention was rather to find a biogenic reactive resin of which the curing behavior is comparable to that of fossil reactive resins. In addition, a reactive resin component made from the biogenic reactive resin should have an acceptable failure bond stress.

This object is achieved by using a (meth)acrylate based on a dianhydrohexitol derivative, in particular a dianhydrohexitol bis-glycidyl ether. This has the advantage that for the synthesis of the reactive resin components it is possible to use starting compounds which can be obtained from renewable raw materials in sufficient quantity and quality. In particular functionalized dianhydrohexitol compounds which can be obtained by reacting a dianhydrohexitol bis-glycidyl ether with (meth)acrylic acid have proven to be advantageous in the context of the present invention. As the tests described here in the examples show, such compounds have a good curing profile. In addition, the failure bond stress of reactive resin components containing the functionalized dianhydrohexitol compounds is within an acceptable range.

For a better understanding of the present invention, the following explanations of the terminology used herein are considered useful. In the context of the invention:
“sugar” means a saccharide, in particular a monosaccharide. preferably an aldose or ketose. For the present invention, if, in addition to the dianhydrohexitol compound used according to the invention, other sugar compounds are also present in the reactive resin or the reactive resin component, pentoses or hexoses are preferably used for the further sugar compounds. Unless otherwise stated, the sugar in the other sugar compounds can be used in its open-chain form or, if such a form exists. in its cyclic form. For the present invention, a furanose or pyranose, i.e. the cyclic hemiacetal or acetal of a hexose, is preferably used as the sugar in the further sugar compound. Furthermore, a sugar methacrylate is preferred as a further sugar compound;
“sugar derivative” means a derivative of a sugar, in particular a derivative derived from a sugar by reduction or dehydration. The sugar derivatives also include the dianhydrohexitols present in the dianhydrohexitol compounds used according to the invention, but these will be described further below;
“base resin” means a typically solid or high-viscosity radically polymerizable resin which cures by polymerization (e.g. after addition of an initiator in the presence of an accelerator);
“reactive resin master batch” means the reaction product of the reaction for producing the backbone resin, i.e. typically a mixture of backbone resin, stabilizer and other constituents of the reaction mixture;
“reactive resin” means a mixture of a reactive resin master batch, an accelerator and an inhibitor (also referred to as an accelerator-inhibitor system), a reactive diluent and optionally further additives; the reactive resin is typically liquid or viscous and can be further processed to form a reactive resin component;
“inhibitor” or “polymerization inhibitor” means a substance which suppresses unwanted radical polymerization during the synthesis or storage of a resin or a resin-containing composition (these substances are also referred to in the art as “stabilizers”) or which delays the radical polymerization of a resin after addition of a initiator, usually in conjunction with an accelerator (these substances are also referred to in the art as “inhibitors”—the meaning of each term is apparent from the context);
“initiator” means a substance which (usually in combination with an accelerator) forms reaction-initiating radicals;
“accelerator” means a reagent which reacts with the initiator so that larger quantities of free radicals are produced by the initiator even at low temperatures, and/or which catalyzes the decomposition reaction of the initiator;
“reactive diluents” means liquid or low-viscosity monomers and base resins which dilute other base resins or the reactive resin master batch and thereby impart the viscosity necessary for application thereof, which contain functional groups capable of reacting with the base resin, and which for the most part become a constituent of the cured composition (e.g. of the mortar) in the polymerization (curing); reactive diluents are also referred to as co-polymerizable monomers;
“reactive resin component” means a liquid or viscous mixture of reactive resin and fillers and optionally further components, e.g. additives; typically, the reactive resin component is one of the two components of a two-component reactive resin system for chemical fixing;
“hardener component” means a composition containing an initiator for the polymerization of a base resin; the hardener component may be solid or liquid and may contain, in addition to the initiator, a solvent and fillers and/or additives; typically the hardener component, in addition to the reactive resin component, is the other of the two components of a two-component reactive resin chemical fixing system;
“two-component system” or “two-component reactive resin system” means a reactive resin system comprising two separately stored components, a reactive resin component (A) and a hardener component (B), so that curing of the base resin contained in the reactive resin component takes place after the mixing of the two components;
“multi-component system” or “multi-component reactive resin system” means a reactive resin system comprising a plurality of separately stored components, including a reactive resin component (A) and a hardener component (B), so that curing of the base resin contained in the reactive resin component takes place after the mixing of all components;
“(meth)acrylic (meth)acrylic . . . ” means both the “methacrylic methacrylic” and the “acrylic . . . / . . . acrylic . . . ” compounds; “methacrylic . . . / . . . methacrylic” compounds are preferred in the present invention;
“a,”“an,”“any,” as the indefinite article preceding a class of chemical compounds, e.g. preceding the term “dianhydrohexitol compound,” means that one or more compounds included in this class of chemical compounds, e.g. various dianhydrohexitol compounds, may be intended. In a preferred embodiment, this article means only a single compound;
“at least one” means numerically “one or more.” In a preferred embodiment, the term means numerically “one”;
“contain,” “comprise,” and “include” mean that further constituents may be present in addition to those mentioned. These terms are intended to be inclusive and therefore encompass “consist of.” “Consist of” is intended to be exclusive and means that no further constituents may be present. In a preferred embodiment, the terms “contain,” “comprise” and “include” mean the term “consist of”;
“approximately” or “about” or “approx.” before a numerical value means a range of ±5% of this value, preferably ±2% of this value, more preferably ±1% of this value, particularly preferably ±0% of this value (i.e., exactly this value);
a range limited by numbers, e.g. “from 100° C. to 120° C.,” means that the two extreme values and any value within this range are disclosed individually.

A first subject of the invention relates to a reactive resin comprising at least one dianhydrohexitol compound of the formula (I),

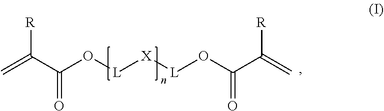

in which R represents a hydrogen atom or a methyl group, X represents a dianhydrohexitol, the instances of L represent, independently of one another, a bridging C₁-C₈ alkylene group, which may be unsubstituted or hydroxy-substituted, and n may be 1 to 5.

The inventors have succeeded in providing, based on a dianhydrohexitol compound of the formula (I), a component which can be used as a base resin or as a reactive diluent, can be prepared from renewable raw materials, and has an acceptable curing time.

The reactive resin according to the invention comprises at least one dianhydrohexitol compound of the formula (I), where X represents a dianhydrohexitol.

dianhydrohexitols, more precisely 1.4:3.6-dianhydrohexitols, are by-products of the starch industry and are therefore obtained from renewable raw material compounds. They can be obtained, for example, by dehydrogenating D-hexitols, which in turn can be obtained from hexose sugars by simple reduction, The dianhydrohexitols are therefore chiral products obtainable from biomass. Depending on the configuration of the two hydroxyl groups, a distinction is made between three isomers, the isosorbide (structure A), the isomannide (structure B) and the isoidide (structure C), which are obtained from hydrogenation and subsequent double dehydration from D-glucose, D-mannose or the L-fructose.

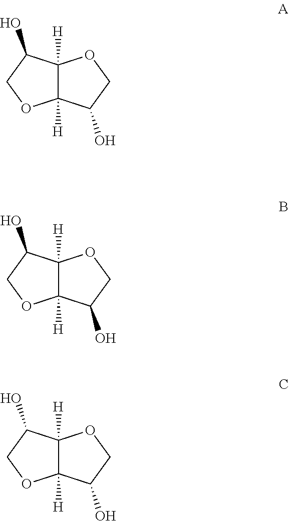 [SMILES: O[C@@H]1CO[C@H]2[C@@H]1OC[C@@H]2O ; O[C@@H]1CO[C@H]2[C@@H]1OC[C@H]2O ; O[C@H]1CO[C@H]2[C@@H]1OC[C@@H]2O]

The dianhydrohexitols used as the starting compound for the compound of the formula (I) can thus be an isosorbide, isomannide or isoidide or a mixture of these dianhydrohexitols. In the following, the term dianhydrohexitols is to be understood to mean the relevant discrete compound as well as any mixture of the various individual compounds. Since the isosorbide is most widespread, it is preferably used as the starting compound for the dianhydrohexitol compounds according to the invention.

The dianhydrohexitols described here typically contain one or more stereocenters. Since the dianhydrohexitols used in the invention are advantageously biogenic dianhydrohexitols, they typically have the same stereochemistry as their natural precursors, for example D-isosorbide has the same stereochemistry as its natural precursor D-glucose. If no stereochemistry is given below, the stereochemistry is typically the natural stereochemistry. However, the use of sugars, sugar derivatives or dianhydrohexitols with non-natural stereochemistry is also possible.

The dianhydrohexitol compounds used according to the invention preferably contain a dianhydrohexitol selected from the group consisting of isosorbide, isomannide and isoidide or a mixture of two or more of these compounds. The dianhydrohexitol compounds used according to the invention particularly preferably contain isosorbide or a mixture of isosorbide and one or more other dianhydrohexitols.

According to the invention, the dianhydrohexitol compounds of the formula (I) contain at least one (meth)acrylic ester group which is bonded to the dianhydrohexitol X via a bridging alkylene group L, which can be unsubstituted or hydroxy-substituted. The dianhydrohexitol X is preferably etherified on at least one, more preferably on all hydroxyl groups with the bridging alkylene group L, which is esterified with at least one (meth)acrylic ester group.

Accordingly, the dianhydrohexitol compounds according to the invention are preferably a compound of the formula (la) without specifying the stereochemistry at the chiral carbon atoms,

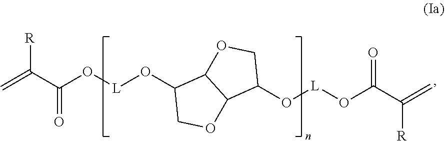

where R, L and n have the meanings given above.

The dianhydrohexitol X is preferably isosorbide.

Accordingly, the dianhydrohexitol compound according to the invention is preferably a compound of the formula (Ib),

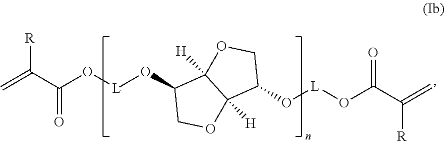

where R, L and n have the meanings given above.

According to the invention, the bridging alkylene group L is a C₁-C₈ alkylene group, which can be unsubstituted or hydroxy-substituted.

The bridging alkylene group L is preferably a C₂-C₆ alkylene group, more preferably a C₃-C₅ alkylene group. According to a particularly preferred embodiment, the bridging alkylene group L is a C₃ alkylene group.

The bridging alkylene group L can be unsubstituted or hydroxy-substituted. The bridging alkylene group is preferably hydroxy-substituted. Accordingly, the bridging alkylene group L is preferably substituted with at least one hydroxyl group.

According to a particularly preferred embodiment, the bridging alkylene group L is a C₃ alkylene group which is substituted with at least one hydroxyl group, particularly preferably with a hydroxyl group.

Accordingly, the bridging alkylene group L preferably has the following structure:

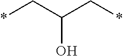 [SMILES: *CC(O)C*]

The L groups can be different from one another, but are preferably the same.

Furthermore, the substituent R is preferably a methyl group.

The parameter n preferably has values in the range of from 1 to 3, more preferably 1 to 2. The parameter n particularly preferably has the value 1.

The dianhydrohexitol compound used according to the invention therefore preferably has the following structure without specifying the stereochemistry at the chiral carbon atoms:

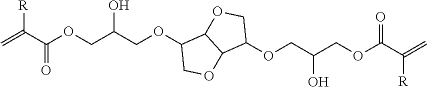

The starting material for the dianhydrohexitol compounds according to the invention is preferably a dianhydrohexitol bis-glycidyl ether having the following structure:

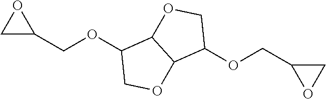 [SMILES: C1OC1COC1COC2C(OCC3CO3)COC12]

The synthesis of such dianhydrohexitol bis-glycidyl ethers is known to a person skilled in the art. WO 2010/040464, for example, describes the synthesis of isosorbide-bis-glycidyl ether by reacting isosorbide with epichlorohydrin.

According to the invention, a dianhydrohexitol bis-glycidyl ether is reacted with (meth)acrylic acid in the presence of a catalyst to synthesize the dianhydrohexitol compound. The catalyst is preferably a quaternary ammonium halide; tetraethylammonium bromide is particularly preferred.

Due to the preparation process, the dianhydrohexitol compounds according to the invention typically also contain residues of unesterified or only mono-esterified dianhydrohexitol bis-glycidyl ether. Likewise, the dianhydrohexitol compounds according to the invention can also contain small proportions of unepoxidized or mono-epoxidized dianhydrohexitol, which is converted to dianhydrohexitol di(meth)acrylate or dianhydrohexitol (meth)acrylate in the reaction with (meth)acrylic acid. Accordingly, the dianhydrohexitol compounds according to the invention can contain impurities of the following structures:

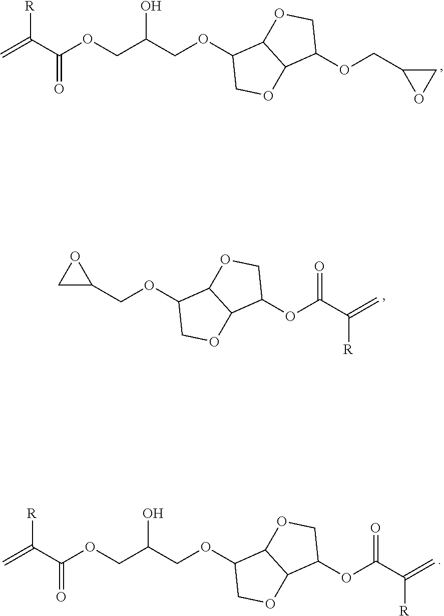

Despite these impurities, these products are referred to as dianhydrohexitol compounds in the context of the present invention, unless the context indicates that a single molecule of these compounds is meant.

If all the starting compounds are obtained from renewable raw materials, such as biomass, up to 80% of the carbon content of the reactive resin can come from renewable raw materials.

Additionally or alternatively, the reactive resin according to the invention preferably contains up to 70 wt. %, more preferably up to 60 wt. %, even more preferably up to 30 wt. %, yet more preferably up to 12 wt. %, particularly preferably up to 10 wt. %, of the at least one dianhydrohexitol compound of the formula (I), based on the total weight of the reactive resin.

In addition to the at least one dianhydrohexitol compound of the formula (I), the reactive resin according to the invention preferably contains at least one co-polymerizable monomeric compound which carries at least two (meth)acrylate groups.

Suitable co-polymerizable monomeric compounds are, for example, vinyl ester resins which have unsaturated groups only in the end position. These are obtained, for example, by reacting epoxy monomers, oligomers or polymers (for example bisphenol A digylcidyl ether, phenol novolak-type epoxides or epoxy oligomers based on tetrabromobisphenol A) with, for example, (meth)acrylic acid or (meth)acrylamide. Preferred vinyl ester resins are (meth)acrylate-functionalized resins and resins which are obtained by reacting an epoxy monomer, oligomer or polymer with methacrylic acid or methacrylamide, preferably with methacrylic acid. Examples of such compounds are known from the applications U.S. Pat. No. 3,297,745 A, U.S. Pat. No. 3,772,404 A, U.S. Pat. No. 4,618,658 A, GB 2 217 722 A1, DE 37 44 390 A1 and DE 41 31 457 A1.

Particularly suitable and preferred as vinyl ester resin are (meth)acrylate-functionalized resins which are obtained, for example, by reacting difunctional and/or higher-functional isocyanates with suitable acrylic compounds, optionally with the involvement of hydroxy compounds which contain at least two hydroxyl groups, as described in DE 3940309 A1, for example.

Aliphatic (cyclic or linear) and/or aromatic difunctional or higher-functional isocyanates or prepolymers thereof can be used as isocyanates. The use of such compounds serves to increase the wettability and thus to improve the adhesive properties. Aromatic difunctional or higher-functional isocyanates or prepolymers thereof are preferred, aromatic difunctional or higher-functional prepolymers being particularly preferred. Examples include toluene diisocyanate (TDI), diisocyanatodiphenylmethane (MDI) and polymeric diisocyanatodiphenylmethane (pMDI) to increase chain reinforcement and hexane diisocyanate (HDI) and isophorone diisocyanate (IPDI), which improve flexibility, from which polymeric diisocyanatodiphenylmethane is particularly preferred.

Suitable acrylic compounds are acrylic acid and acrylic acids substituted on the hydrocarbon group, such as methacrylic acid. hydroxyl-containing esters of acrylic or methacrylic acid with polyhydric alcohols, pentaerythritol tri(meth)acrylate, glycerol di(meth)acrylate, such as trimethylol propane di(meth)acrylate, neopentyl glycol mono(meth)acrylate. Preference is given to acrylic or methacrylic acid hydroxyl alkyl esters, such as hydroxyethyl (meth)acrylate, hydroxypropyl (meth)acrylate, polyoxyethylene (meth)acrylate, polyoxypropylene (meth)acrylate, especially since such compounds are used to sterically prevent the saponification reaction.

Dihydric or higher-hydric alcohols are suitable as difunctional or higher-functional hydroxy compounds, for example secondary products of ethylene or propylene oxide, such as ethanediol, di- or triethylene glycol, propanediol, dipropylene glycol, other diols, such as 1,4-butanediol, 1,6-hexanediol, neopentyl glycol, diethanolamine, furthermore bisphenol-A or F or their ethoxylation and/or hydrogenation or halogenation products, higher-hydric alcohols, such as glycerol, trimethylolpropane, hexanetriol and pentaerythritol, hydroxyl group-containing polyethers, e.g. oligomers of aliphatic or aromatic oxiranes and/or higher cyclic ethers, e.g. ethylene oxide, propylene oxide, styrene oxide and furan, polyethers containing aromatic structural units in the main chain, e.g. those of the bisphenol A or F, hydroxyl group-containing polyesters based on the above alcohols or polyethers and dicarboxylic acids or their anhydrides, e.g. adipic acid, phthalic acid, tetra- or hexahydrophthalic acid, hetic acid, maleic acid, fumaric acid, itaconic acid, sebacic acid and the like. Particular preference is given to hydroxy compounds having aromatic structural units for reinforcing the chain of the resin, hydroxy compounds which contain unsaturated structural units, such as fumaric acid, for increasing the crosslinking density, branched or star-shaped hydroxy compounds, in particular trihydric or higher-hydric alcohols and/or polyethers or polyesters containing their structural units, branched or star-shaped urethane (meth)acrylates for achieving lower viscosity of the resins or their solutions in reactive diluents and higher reactivity and crosslinking density.

According to a preferred embodiment of the present invention, the vinyl ester resin is a reaction product of diisocyanatodiphenylmethane (MDI), hydroxypropyl (meth)acrylate, and dipropylene glycol. The preparation of the vinyl ester resin is described in EP 0 713 015 A1 which is hereby introduced as a reference and reference is made to the entire disclosure thereof.

The reactive resin according to the invention preferably contains up to 99.0 wt. %, more preferably 70.0 to 95.0 wt. %, even more preferably 80.0 to 94.0 wt. %, particularly preferably 85.0 to 90.0 wt. %, of the co-polymerizable monomeric compound, based on the total weight of the reactive resin.

Accordingly, the reactive resin according to the invention preferably contains up to 70 wt. %, more preferably up to 60 wt. %, even more preferably up to 30 wt. %, yet more preferably up to 12 wt. %, particularly preferably up to 10 wt. %, of the at least one dianhydrohexitol compound of the formula (I) and up to 99.0 wt. %, more preferably 70.0 to 95,0 wt. %, even more preferably 80.0 to 94.0 wt. %, particularly preferably 85.0 to 90.0 wt. %, of the co-polymerizable monomeric compound, based on the total weight of the reactive resin.

Reactive resins are generally produced by adding the starting compounds required for the preparation of the base resin, optionally together with catalysts and solvents, in particular reactive diluents, to a reactor and reacting them with one another. After the end of the reaction and optionally already at the beginning of the reaction, polymerization inhibitors for storage stability are added to the reaction mixture, as a result of which the resin master batch is obtained. Accelerators for curing the base resin, optionally further polymerization inhibitors, which may or may not be the same as the polymerization inhibitor for storage stability, for adjusting the gel time, and optionally further solvents, in particular reactive diluents, are often added to the resin master batch, as a result of which the reactive resin is obtained. This reactive resin is mixed with inorganic and/or organic additives in order to adjust various properties, such as the rheology and the concentration of the base resin, as a result of which a reactive resin component is obtained.

A preferred reactive resin accordingly contains at least one base resin, at least one reactive diluent and at least one polymerization inhibitor. In addition to the reactive resin just described, a reactive resin component contains inorganic and/or organic aggregates, inorganic aggregates being particularly preferred, as described in more detail below.

In a preferred embodiment of the invention, the reactive resin contains further low-viscosity, radically polymerizable compounds, preferably those which are obtainable from renewable raw materials, as reactive diluents, in order to adjust the viscosity of the vinyl ester urethane resins or the precursors during their preparation. if necessary. In this context, reference is made to WO 09/156648 A1, WO 10/061097 A1, WO 10/079293 A1 and WO 10/099201 A1, the contents of which are hereby incorporated into this application.

Alternatively, the reactive resin may contain any suitable reactive diluent. Expediently, the reactive resin contains, as a reactive diluent, an aliphatic or aromatic C₅-C₁₅ (meth)acrylic acid ester, (meth)acrylic acid esters being particularly preferably selected from the group consisting of hydroxypropyl(meth)acrylate, 1,2-ethanediol di(meth)acrylate, 1,3-propanediol di(meth)acrylate, 1,2-butanediol di(meth)acrylate, 1,4-butanediol di(meth)acrylate, trimethylolpropane tri(meth)acrylate, phenethyl(meth)acrylate, tetrahydrofurfuryl (meth)acrylate, ethyltriglycol (meth)acrylate, NW-dimethylaminoethyl (meth)acrylate, N,N-dimethylaminomethyl (meth)acrylate, acetoacetoxyethyl (meth)acrylate, isobomyl (meth)acrylate, 2-ethylhexyl(meth)acrylate, diethyleneglycol di(meth)acrylate, methoxypolyethylene glycol mono(meth)acrylate, trimethylcyclohexyl (meth)acrylate, 2-hydroxyethyl (meth)acrylate, dicyclopentenyloxyethyl (meth)acrylate and/or tricyclopentadienyl di(meth)acrylate, bisphenol-A-(meth)acrylate, novolak epoxy di(meth)acrylate, di-[(meth)acryloyl-maleoyl]tricyclo-5.2.1.0.^{2.6}-decane, dicyclopentenyloxyethylcrotonat, 3-(meth)acryloyl-oxymethyl-tricylo-5.2.1.0.^{2.6}-decane, 3-(meth)cyclopentadienyl (meth)acrylate, isobornyl (meth)acrylate and decalyl-2-(meth)acrylate; PEG-di(meth)acrylate such as PEG200 di(meth)acrylate, tetraethylene glycol di(meth)acrylate, solketal (meth)acrylate, cyclohexyl (meth)acrylate, phenoxyethyl di(meth)acrylate, methoxyethyl (meth)acrylate, tert-butyl (meth)acrylate and norbornyl (meth)acrylate. In principle, other conventional radically polymerizable compounds, alone or in a mixture with the (meth)acrylic acid esters, can also be used as reactive diluents, e.g. styrene, α-methylstyrene, alkylated styrenes, such as tert-butylstyrene, divinylbenzene and allyl compounds, of which the representatives that can be obtained from base chemicals based on renewable raw materials are preferred.

The reactive resin according to the invention preferably contains 5.0 to 50.0 wt. %, more preferably 10.0 to 30,0 wt. %, even more preferably 15.0 to 25.0 wt. %, particularly preferably 18.0 to 20.0 wt. %, of the reactive diluent, based on the total weight of the reactive resin.

Accordingly, the reactive resin according to the invention preferably contains up to 70 wt. %, more preferably up to 60 wt. %, even more preferably up to 30 wt. %, yet more preferably up to 12 wt. %, particularly preferably up to 10 wt. %, of the at least one dianhydrohexitol compound of the formula (I), and up to 99.0 wt. %, more preferably 70.0 to 95.0 wt. %, even more preferably 80.0 to 94.0 wt. %, particularly preferably 85.0 to 90.0 wt. %, of the co-polymerizable monomeric compound, and 5.0 to 50.0 wt. %, more preferably 10.0 to 30.0 wt. %, even more preferably 15.0 to 25,0 wt. %, particularly preferably 18.0 to 20.0 wt. %, of the reactive diluent, based on the total weight of the reactive resin.

To stabilize against premature polymerization (storage stability) and to adjust the gel time and reactivity, the reactive resin can contain a polymerization inhibitor. To ensure storage stability, the polymerization inhibitor is preferably contained in an amount of from 0.0005 to 2 wt. %, more preferably 0.01 to 1 wt. %, based on the total weight of the reactive resin. To adjust the gel time and the reactivity, the reactive resin can additionally contain 0.005 to 3 wt. %, preferably 0.05 to 1 wt. %, of a polymerization inhibitor.

According to the invention, the polymerization inhibitors which are conventionally used for radically polymerizable compounds, as are known to a person skilled in the art, are suitable as polymerization inhibitors.

To stabilize against premature polymerization, reactive resin and reactive resin components usually contain polymerization inhibitors, such as hydroquinone, substituted hydroquinones, for example 4-methoxyphenol, phenothiazine, benzoquinone or tert-butyl catechol, as described, for example, in EP 1935860 A1 or EP 0965619 A1, stable nitroxyl radicals, and N-oxyl radicals, such as piperidinyl-N-oxyl or tetrahydropyrrole-N-oxyl, as described, for example, in DE 19531649 A1. 4-Hydroxy-2,2,6,6-tetramethylpiperidine-N-oxyl (also referred to as TEMPOL) is particularly preferably used for stabilization, which has the advantage that the gel time can also be adjusted thereby.

These further inhibitors are preferably selected from phenolic compounds and non-phenolic compounds, such as stable radicals and/or phenothiazines.

Phenols, such as 2-methoxyphenol, 4-methoxyphenol, 2,6-di-tert-butyl-4-methylphenol, 2,4-di-tert-butylphenol, 2,6-di-tert-butylphenol, 2,4,6-trimethylphenol, 2,4,6-tris(dimethylaminomethyl)phenol, 4,4′-thio-bis(3-methyl-6-tert-butylphenol), 4,4′-isopropylidenediphenol, 6,6′-di-tert-butyl-4,4′-bis(2,6-di-tert-butylphenol), 1,3,5-trimethyl-2,4,6-tris(3,5-di-tert-butyl-4-hydroxybenzyl)benzene, 2,2′-methylene-di-p-cresol, pyrocatechol, and butylpyrocatechols such as 4-tert-butylpyrocatechol and 4,6-di-tert-butylpyrocatechol, hydroquinones such as hydroquinone, 2-methylhydroquinone, 2-tert-butylhydroquinone, 2,5-di-tert-butylhydroquinone, 2,6-di-tert-butylhydroquinone, 2,6-dimethylhydroquinone, 2,3,5-trimethylhydroquinone, benzoquinone, 2,3,5,6-tetrachloro-1,4-benzoquinone, methylbenzoquinone, 2,6-dimethylbenzoquinone, naphthoquinone, or mixtures of two or more thereof, are suitable as phenolic polymerization inhibitors that are often a constituent of commercial radically curing reactive resins.

Phenothiazines such as phenothiazine and/or derivatives or combinations thereof, or stable organic radicals such as galvinoxyl and N-oxyl radicals, are preferably considered as non-phenolic polymerization inhibitors.

Suitable stable N-oxyl radicals (nitroxyl radicals) can be selected from 1-oxyl-2,2,6,6-tetramethylpiperidine, 1-oxyl-2,2,6,6-tetramethylpiperidin-4-ol (also referred to as TEMPOL), 1-oxyl-2,2,6,6-tetramethylpiperidin-4-one (also referred to as TEMPON), 1-oxyl-2,2,6,6-tetramethyl-4-carboxyl-piperidine (also referred to as 4-carboxy- TEMPO), 1-oxyl-2,2,5,5-tetramethylpyrrolidine, 1-oxyl-2,2,5,5-tetramethyl-3-carboxylpyrrolidine (also referred to as 3-carboxy-PROXYL), aluminum-N-nitrosophenylhydroxylamine, and diethylhydroxylamine, as described in DE 199 56 509. Further suitable N-oxyl compounds are oximes, such as acetaldoxime, acetone oxime, methyl ethyl ketoxime, salicyloxime, benzoxime, glyoximes, dimethylglyoxime, acetone-O-(benzyloxycarbonyl)oxime and the like. Furthermore, pyrimidinol or pyridinol compounds substituted in para-position to the hydroxyl group, as described in the patent DE 10 2011 077 248 B1, can be used as stabilizers.

The polymerization inhibitors may be used either alone or as a combination of two or more thereof, depending on the desired properties of the reactive resin and the use of the reactive resin. The combination of phenolic and non-phenolic inhibitors allows a synergistic effect, such as substantially drift-free adjustment of the gel time of the reactive resin.

The reactive resin according to the invention preferably contains, more preferably consists of, up to 70 wt. %, more preferably up to 60 wt. %, even more preferably up to 30 wt. %, yet more preferably up to 12 wt. %, particularly preferably up to 10 wt. %, of the at least one dianhydrohexitol compound of the formula (I), and up to 99.0 wt. %, more preferably 70.0 to 95.0 wt. %, even more preferably 80.0 to 94.0 wt. %, particularly preferably 85.0 to 90.0 wt. %, of the co-polymerizable monomeric compound, and 5.0 to 50.0 wt. %, more preferably 10.0 to 30.0 wt. %, even more preferably 15.0 to 25.0 wt. %, particularly preferably 18.0 to 20.0 wt. %, of the reactive diluent, and 0.0005 to 2 wt. %, more preferably 0.01 to 1 wt. %, of the polymerization inhibitor, based on the total weight of the reactive resin.

The curing of the resin component is preferably initiated with a radical initiator, such as a peroxide. In addition to the radical initiator, an accelerator can also be used. As a result, fast-curing reactive resin components are obtained, which are cold-curing, i.e. which cure at room temperature. Suitable accelerators, which are usually added to the reactive resin, are known to a person skilled in the art. These are, for example, amines, preferably tertiary amines and/or metal salts.

Suitable amines are selected from the following compounds, which are described in the application US 2011071234 A1, for example: dimethylamine, trimethylamine, ethylamine, diethylamine, triethylamine, n-propylamine, di-n-propylamine, tri-n-propylamine, isopropylamine, diisopropylamine, triisopropylamine, n-butylamine, isobutylamine, tert-butylamine, di-n-butylamine, diisobutylamine, triisobutylamine, pentylamine, isopentylamine, diisopentylamine, hexylamine, octylamine, dodecylamine, laurylamine, stearylamine, aminoethanol, diethanolamine, triethanolamine, aminohexanol, ethoxyaminoethane, dimethyl-(2-chloroethyl)amine, 2-ethylhexylamine, bis-(2-chloroethyl)amine, 2-ethylhexylamine, bis-(2-ethylhexyl)amine, N-methylstearylamine, dialkylamines, ethylenediamine, N,N′-dimethylethylenediamine, tetramethylethylenediamine, diethylenetriamine, permethyldiethylenetriamine, triethylenetetramine, tetraethylenepentamine, 1,2-diaminopropane, di-propylenetriamine, tripropylenetetramine, 1,4-diaminobutane, 1,6-diaminohexane, 4-amino-1-diethylaminopentane, 2,5-diamino-2,5-dimethylhexane, trimethylhexamethylenediamine, N,N-dimethylaminoethanol, 2-(2-diethylaminoethoxy)ethanol, bis-(2-hydroxyethyl)oleylamine, tris-[2-(2-hydroxyethoxy)ethyl]amine, 3-amino-1-propanol, methyl-(3-aminopropyl)ether, ethyl-(3-aminopropyl)ether, 1,4-butanediol-bis(3-aminopropyl ether), 3-dimethylamino-1-propanol, 1-amino-2-propanol, 1-diethylamino-2-propanol, diisopropanolamine, methyl-bis-(2-hydroxypropyl)amine, tris-(2-hydroxypropyl)amine, 4-amino-2-butanol, 2-amino-2-methylpropanol, 2-amino-2-methylpropanediol, 2-amino-2-hydroxymethylpropanediol, 5-aethylamino-2-pentanone, 3-methylaminopropionitrile, 6-aminohexanoic acid, 11-aminoundecanoic acid, 6-aminohexanoic acid ethyl ester, 11-aminohexanoate-isopropyl ester, cyclohexylamine, N-methylcyclohexylamine, N,N-dimethylcyclohexylamine, dicyclohexylamine, N-ethylcyclohexylamine, N-(2-hydroxyethyl)-cyclohexylamine, N,N-bis-(2-hydroxyethyl)-cyclohexylamine, N-(3-aminopropyl)-cyclohexylamine, aminomethylcyclohexane, hexahydrotoluidine, hexahydrobenzylamine, aniline, N-methylaniline, N,N-dimethylaniline, N,N-diethylaniline, N,N-di-propylaniline, iso-butylaniline, toluidine, diphenylamine, hydroxyethylaniline, bis-(hydroxyethyl)aniline, chloroaniline, aminophenols, aminobenzoic acids and esters thereof, benzylamine, dibenzylamine, tribenzylamine, methyldibenzylamine, a-phenylethylamine, xylidine, diisopropylaniline, dodecylaniline, aminonaphthalin, N-methylaminonaphthalin, N,N-dimethylaminonaphthalin, N,N-dibenzylnaphthalin, diaminocyclohexane, 4,4′-diamino-dicyclohexylmethane, diamino-dimethyl-dicyclohexylmethane, phenylenediamine, xylylenediamine, diaminobiphenyl, naphthalenediamines, toluidines, benzidines, 2,2-bis-(aminophenyl)-propane, aminoanisoles, amino-thiophenols, aminodiphenyl ethers, aminocresols, morpholine, N-methylmorpholine, N-phenylmorpholine, hydroxyethylmorpholine, N-methylpyrrolidine, pyrrolidine, piperidine, hydroxyethylpiperidine, pyrroles, pyridines, quinolines, indoles, indolenines, carbazoles, pyrazoles, imidazoles, thiazoles, pyrimidines, quinoxalines, aminomorpholine, dimorpholineethane, [2,2,2]-diazabicyclooctane and N,N-dimethyl-p-toluidine.

Preferred amines are aniline derivatives and N,N-bisalkylarylamines, such as N,N-dimethylaniline, N,N-diethylaniline, N,N-dimethyl-p-toluidine, N,N-bis(hydroxyalkyl)arylamines, N,N-bis(2-hydroxyethyl)aniline, N,N-bis(2-hydroxyethyl) toluidine, N,N-bis(2-hydroxypropyl)aniline, N,N-bis(2-hydroxypropyl)toluidine, N,N-bis(3-methacryloyl-2-hydroxypropyl)-p-toluidine, N,N-dibutoxyhydroxypropyl-p-toluidine and 4,4′-bis(dimethylamino)diphenylmethane.

Polymeric amines, such as those obtained by polycondensation of N,N-bis(hydroxyalkyl)aniline with dicarboxylic acids or by polyaddition of ethylene oxide to these amines, are also suitable as accelerators.

Suitable metal salts are, for example, cobalt octoate or cobalt naphthenoate as well as vanadium, potassium, calcium, copper, manganese or zirconium carboxylate.

If an accelerator is used, it is used in an amount of from 0.01 to 10 wt. %, preferably from 0.2 to 5 wt. %, based on the total weight of the reactive resin,

Another subject of the present invention is the use of the reactive resin described above for the chemical fastening of an anchoring means in a borehole.

The anchoring means is preferably made of steel or iron.

According to a particularly preferred embodiment of the present invention, the borehole is a borehole in a mineral or metal substrate, preferably a substrate selected from the group consisting of concrete, aerated concrete, brickwork, limestone, sandstone, natural stone, glass and steel.

Another subject of the invention is a reactive resin component which, in addition to the reactive resin just described, contains inorganic and/or organic aggregates, such as fillers and/or other additives.

The proportion of the reactive resin in the reactive resin component is preferably 10 to 60 wt. %, more preferably 20 to 35 wt. %, based on the total weight of the reactive resin component. Correspondingly, the proportion of aggregates is preferably 90 to 40 wt. %, more preferably 80 to 65 wt. %, based on the total weight of the reactive resin component.

The fillers used are conventional fillers, preferably mineral or mineral-like fillers, such as quartz, glass, sand, quartz sand, quartz powder, porcelain, corundum, ceramics, talc, silicic acid (e.g. fumed silica), silicates, clay, titanium dioxide, chalk, barite, feldspar, basalt, aluminum hydroxide, granite or sandstone, polymeric fillers such as thermosets, hydraulically curable fillers such as gypsum, quicklime or cement (e.g. alumina cement or Portland cement), metals such as aluminum, carbon black, furthermore wood, mineral or organic fibers, or the like, or mixtures of two or more thereof, which can be added as powder, in granular form or in the form of molded bodies. The fillers may be present in any desired forms, for example as powder or flour, or as molded bodies, for example in cylindrical, annular, spherical, platelet, rod, saddle or crystal form, or else in fibrous form (fibrillar fillers), and the corresponding base particles preferably have a maximum diameter of 10 mm. The globular, inert substances (spherical form) have a preferred and more pronounced reinforcing effect. Fillers are present in each component preferably in an amount of up to 90, in particular 3 to 85, especially 5 to 70 wt. %.

Further conceivable additives are also thixotropic agents such as optionally organically after-treated fumed silica, bentonites, alkyl- and methylcelluloses, castor oil derivatives or the like, plasticizers such as phthalic or sebacic acid esters, stabilizers, antistatic agents, thickeners, flexibilizers, curing catalysts, rheology aids, wetting agents, coloring additives such as dyes or in particular pigments, for example for different staining of components for improved control of their mixing, or the like, or mixtures of two or more thereof. Non-reactive diluents (solvents) can also be present, preferably in an amount of up to 30 wt. %, based on the particular component (reactive resin component, hardener component), for example from 1 to 20 wt. %, such as low-alkyl ketones, for example acetone, di-low-alkyl low-alkanoyl amides, such as dimethylacetamide, low-alkylbenzenes, such as xylenes or toluene, phthalic acid esters or paraffins, or water.

In a preferred embodiment of the invention, the reactive resin component according to the invention is manufactured as a two- or multi-component system, in particular a two-component system, the reactive resin component and the hardener component being arranged separately so as to inhibit the reaction.

Accordingly, a further subject of the present invention is a two-component system which comprises the reactive resin component described above and a hardener component.

A first component of the two-component system according to the invention, component A, contains the reactive resin component and a second component, component B, contains the curing agent. This ensures that the curable compounds and the hardener component are mixed with one another, and thus trigger the curing reaction, only immediately before use.

The hardener component contains the curing agent for initiating the polymerization (curing) of the resin component. As already mentioned, this is a radical initiator, preferably a peroxide.

All of the peroxides known to a person skilled in the art that are used to cure vinyl ester resins can be used according to the invention for curing the dianhydrohexitol-based vinyl ester urethane resins. Such peroxides include organic and inorganic peroxides, either liquid or solid, it also being possible to use hydrogen peroxide. Examples of suitable peroxides are peroxycarbonates (of the formula —OO (O)OO-), peroxyesters (of the formula —O (O)OO-), diacyl peroxides (of the formula —O (O)OOO (O)-), dialkyl peroxides (of the formula —OO-) and the like. These may be present as oligomers or polymers. A comprehensive set of examples of suitable peroxides is described, for example, in the application US 2002/0091214-A1, paragraph [0018].

Preferably, the peroxides are selected from the group of organic peroxides. Suitable organic peroxides are: tertiary alkyl hydroperoxides such as test-butyl hydroperoxide and other hydroperoxides such as cumene hydroperoxide, peroxyesters or peracids such as tert-butyl peresters, benzoyl peroxide, peracetates and perbenzoates, lauryl peroxide including (di)peroxyesters, perethers such as peroxy diethyl ether, perketones, such as methyl ethyl ketone peroxide. The organic peroxides used as curing agents are often tertiary peresters or tertiary hydroperoxides, i.e. peroxide compounds having tertiary carbon atoms which are bonded directly to an —O—O-acyl or —OOH group. However, mixtures of these peroxides with other peroxides can also be used according to the invention. The peroxides may also be mixed peroxides, i.e. peroxides which have two different peroxide-carrying units in one molecule. Preferably, benzoyl peroxide (BPO) is used for curing.

The hardener component of the two-component system preferably also contains inorganic aggregates, the aggregates being the same as those that can be added to the reactive resin component.

In a particularly preferred embodiment of the two-component system, the component A also contains, in addition to the reactive resin component, a hydraulically setting or polycondensable inorganic compound and the component B also contains, in addition to the curing agent. water. Such mortar compositions are described in detail in DE 42 31 161 A1. In this case, component A preferably contains, as a hydraulically setting or polycondensable inorganic compound, cement, for example Portland cement or alumina cement, iron oxide-free or iron oxide-low cements being particularly preferred. Gypsum can also be used as a hydraulically setting inorganic compound as such or in a mixture with the cement. Silicatic, polycondensable compounds, in particular soluble, dissolved and/or amorphous silica-containing substances, can also be used as the polycondensable inorganic compound.

The two-component system preferably comprises the component A and the component B, separated in different containers in a reaction-inhibiting manner, for example a multi-chamber device, such as a multi-chamber shell and/or cartridge, from which containers the two components are ejected by the application of mechanical ejection forces or by the application of a gas pressure and are mixed. Another possibility is to produce the two-component system as two-component capsules which are introduced into the borehole and are destroyed by placement of the fixing element in a rotational manner, while simultaneously mixing the two components of the mortar composition. Preferably, in this case a shell system or an injection system is used in which the two components are ejected out of the separate containers and passed through a static mixer in which they are homogeneously mixed and then discharged through a nozzle preferably directly into the borehole.

The reactive resin according to the invention, the reactive resin component and the two-component system are used primarily in the construction sector, for example for the repair of concrete, as polymer concrete, as a coating material based on synthetic resin or as cold-curing road marking. They are particularly suitable for chemical fixing of anchoring elements, such as anchors, reinforcing bars, screws and the like, in boreholes, in particular in boreholes in various substrates, in particular mineral substrates, such as those based on concrete, aerated concrete, brickwork, limestone, sandstone, natural stone and the like.

Another subject of the present invention is the use of the reactive resin component described above for the chemical fastening of an anchoring means in a borehole.

The anchoring means is preferably made of steel or iron.

According to a particularly preferred embodiment of the present invention, the borehole is a borehole in a mineral or metal substrate, preferably a substrate selected from the group consisting of concrete, aerated concrete, brickwork, limestone. sandstone, natural stone, glass and steel.

The following examples serve to explain the invention in greater detail.

### PRACTICAL EXAMPLES

### A) Preparation of the Dianhydrohexitol Compounds

A1) Synthesis of isosorbide-bis-glycidether dimethacrylate 221.7 g isosorbide-bis-glycidyl ether (1.42 mol, DENACOL GSR-101, Nagase ChemteX Corp.) was placed in a reactor preheated to 50° C. (RC-1, Mettler Toledo). 129.1 g methacrylic acid (1.5 mol, Aldrich, 99%), 102 mg (0.595 mmol) 4-hydroxy-2,2,6,6-tetramethylpiperidinyloxyl (Tempol, crushed) and 102 mg (0.514 mmol) phenylthiazine (crushed, SIGMA-Aldrich, purum, 98%) were added to this. The mixture was then stirred for 15 min. Subsequently, 3.734 g (17.77 mmol) tetraethylammonium bromide (TEABr) (Merck, 97%) was carefully added in small portions with stirring. The reactor was closed, connected to a bubble counter and heated to 100° C. composition temperature with stirring (500 rpm). The mass was stirred at 100° C. for a maximum of 6 h. The reaction of the epoxy groups was monitored by means of NMR. The reaction was ended after 6 h at the latest and the composition was cooled to approximately 50° C. and removed as quickly as possible. If necessary, the reaction products can be removed from the reactor by adding a mixture of (2-hydroxypropyl)methacrylate (HPMA) (70 g) and Tempol (70 mg). The mass is ready for mixing into reactive resins.

In three replicate tests, comparable products having a residual content of approximately 9-13 mol. % methacrylic acid were obtained with reaction times between 5 and a maximum of 6 h. No more epoxy groups could be detected by NMR.

B) Investigation of the Curing Behavior

The dianhydrohexitol compounds prepared in Example A1 were added to reactive resins and their curing behavior was then examined. A mixture of reactive resin master batch C1, hydroxypropyl methacrylate (HPMA), the commercial reactive diluent 1,4-butanediol dimethacrylate (1,4-BDDMA), an aromatic amine (as an accelerator for peroxide decomposition) and various stabilizers was used as the standard resin. Different amounts of the prepared dianhydrohexitol compounds were added to this reactive resin. For curing, the reactive resin component thus obtained was mixed with benzoyl peroxide in a suitable ratio (see Table 1).

TABLE 1
Composition of the respective samples

| | Composition | Master | | | | | |
|---|---|---|---|---|---|---|---|
| | (exchange in | batch | | | | | |
| | mol. % unless | C1 | BDDMA | A1 | DiPT | TEMPOL | tBBK |
| Sample | otherwise stated) | [g] | [g] | [g] | [g] | [g] | [g] |
| Reference | 0% A1 | 42.68 | 25.6 | 0 | 1.472 | 0.021 | 0.226 |
| Sample 1 | 20% A1 | 42.68 | 20.48 | 9.53 | 1.4722 | 0.0213 | 0.226 |
| Sample 2 | 40% A1 | 42.68 | 15.36 | 19.06 | 1.472 | 0.021 | 0.2264 |
| Sample 3 | A1 replaces | 34.15 | 25.6 | 8.54 | 1.4727 | 0.0215 | 0.2264 |
| | 20 wt. % of | | | | | | |
| | master batch C1 | | | | | | |
| Sample 4 | 60% A1 | 42.68 | 10.24 | 28.59 | 1.472 | 0.021 | 0.226 |

The temperature-time curve of the curing was then recorded as follows:

Approximately 20 g of the reactive resin to be examined and the corresponding amount of hardener (Perkadox 20S, mass ratio 70:30) were weighed out in a plastic beaker. As the system is sensitive to the ambient temperature, the components must be kept at 25° C. The temperature was controlled in a thermostat (B12/C11 Prüfgerätewerk Medingen GmbH). The measurement was started immediately before the reaction components were mixed. The hardener was added to the resin component and stirred well with a wooden spatula for 40 s. The mixture was poured into two test tubes approximately 6 cm high, each of which was suspended separately in a measuring cylinder located in the thermostat. A temperature sensor (K-type, 150 mm long ∅1.5 mm) coated with silicone paste was then immersed in the middle of each mixture at a depth of 2 cm. Since the ambient temperature was registered until the sensors were immersed, the shape of the curve at the start of the measurement is not relevant, which is why the temperature-time curves were only used for the evaluation from 100 seconds. The temperature curve was registered by means of the sensors connected to a Voltkraft Datalogger K202 (connected to a PC). The maximum temperature of the curve (Tₘₐₓ) and the time at 35° C. were read off as results in the shape of the curve (schematic evaluation shown in FIG. 1). Three duplicate determinations were made per system.

The results are summarized in Table 2; the temperature-time curves are shown in FIG. 2.

TABLE 2
Results of the curing tests

| | mol. % 1,4- | | | | |
|---|---|---|---|---|---|
| | BDDMA replaced | | | | |
| | (exchange in | | | | |
| | mol. % unless | Tₘₐₓ | σ | tₘₐₓ | σ |
| Sample | otherwise stated) | [° C.] | [° C.] | [min] | [min] |
| Reference | 0 | 153 | 2 | 06:17 | 00:12 |
| Sample 1 | 20% | 154 | 2 | 04:25 | 00:05 |
| Sample 2 | 40% | 151 | 1 | 03:29 | 00:02 |
| Sample 3 | 20 wt. % UMA | 157 | 1 | 05:38 | 00:05 |
| Sample 4 | 60% | 144 | 8 | 02:25 | 00:05 |

The maximum temperature of the composition and the time taken to reach this temperature tₘₐₓ were evaluated as the results of these measurements. A Tₘₐₓ (a measure of the heat of polymerization released during curing) that is comparable to the reference indicates the desired incorporation of the added reaction products into the network being formed. The percentages given in Table 2 for the addition of the new monomers in mol. % are based on the proportion of 1,4-EMMA in the mixture. The number of double bonds in the new reactive diluent is taken into account in these calculations, so that there is always an approximately constant amount of reactive double bonds in the mixture.

The results show that the maximum temperatures in all the tests remain approximately the same up to 40 mol.% replacement of 1,4-EMMA. Only when 60 mol. % 1,4-BDDMA is replaced does Tmax decrease to 144° C. This demonstrates the good incorporation of the isosorbide derivatives into the network being formed. In contrast, the times until the Tₘₐₓ is set decrease as the amount of isosorbide derivatives increases. The results show that 1,4-BDDMA can be replaced by the new, partially bio-based, reactive additives without this having a negative effect on the curing reaction. In addition, parts of the base resin UMA can also be replaced by the isosorbide derivatives instead of the 1,4-EMMA without this having a negative effect on the curing reaction.

### C) Preparation of Reactive Resin Systems

### Reactive Resin Master Batch C1

The reactive resin master batch was synthesized with 65 wt. % of the comparative compound 1 as the base resin and 35 wt. % hydroxypropyl methacrylate (Visiomer® HPMA; Evonik Degussa GmbH), in each case based on the total weight of the reactive resin master batch, according to the method in EP 0 713 015 A1, which is hereby introduced as a reference and reference is made to the entire disclosure thereof. The product has the following structure, there being an oligomer distribution where n=0 to 3:

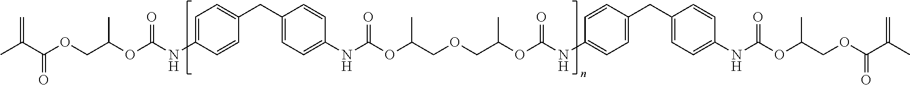

### Reactive Resin Master Batch C2:

531.1 g (26.57 wt. %) of master batch C1 was mixed with 400 g (20 wt. %) 1,4-butanediol dimethacrylate (Visiomer 1 ,4-BDDMA, Evonik Degussa GmbH), 400 g (20 wt. %) hydroxypropyl methacrylate (GEO Specialty Chemicals), 46 g (2.3 wt. %) di-isopropanol-p-toluidine (DiPT; BASF SE), 4.6 g (0.23 wt. %) catechol (Catechol Flakes, RHODIA) and 1 g (0.05 wt. %) tent-butyl pyrocatechol (tBBK, CFS EUROPE S.p.A. (Borregaard Italia S.p.A.)) and stirred until completely homogenized.

### Reactive Resin Master Batch C3 (Reference Reactive Resin)

345.7 g (69.15 wt. %) of master batch C2 was mixed with 154.1 g (30.77 wt. %) of master batch C1, 0.3 g (0.06 wt. %) catechol (Catechol Flakes, RHODIA) and 0.3 g (0.06 wt. %) tert-butyl pyrocatechol (tBBK, CFS EUROPE S.p.A. (Borregaard Italia S.p.A.)) and stirred until completely homogenized.

### Reactive Resin Master Batch C4

345.7 g (69.15 wt. %) of master batch C2 was mixed with 76.95 g (15.39 wt. %) of master batch C1, 50 g (10 wt. %; this corresponds to an exchange of 10 wt. % in the reactive resin for comparative compound 1) isosorbide diglycidyl dimethacrylate, 27 g (5.38 wt. %) hydroxypropyl methacrylate (GEO Specialty Chemicals), 0.3 g (0.06 wt. %) catechol (Catechol Flakes, RHODIA) and 0.3 g (0.06 wt. %) tert-butyl pyrocatechol (tBBK, CFS EUROPE S.p.A. (Borregaard Italia S.p.A.)) and stirred until completely homogenized.

The Reactive Resin Components 05 and 06 were Prepared from the Reactive Resins C3 and C4 as Follows:

310.5 g (34.5 wt. %) of the comparative reactive resin was mixed under vacuum with 166.5 g (18.5 wt. %) of Secar® 80 (Kerneos Inc.), 9 g (1 wt. %) of Cab-O-Sil® TS-720 (Cabot Corporation), 16,2 g of (1.8 wt. %) Aerosil® R 812 (Evonik) and 397.7 g (44.2 wt. %) of quartz sand F32 (Quarzwerke GmbH) in a dissolver. Mixing took place with a PC laboratory system dissolver of the type LDV 0.3-1 for 8 minutes (2 min: 2500 rpm; then 6 min: 3500 rpm; each at a pressure <100 mbar) with a 55 mm dissolver disc and an edge scraper.

The Two-Component Reactive Resin Systems 07 and 08 were Prepared From the Reactive Resin Components C5 and C6 (C7 from C5 and C8 From C6) as Follows:

For the preparation of the two-component reactive resin systems, the reactive resin components (component (A)) were combined with a hardener component (component (B)) of the commercially available product HIT HY-200 (Hilti Aktiengesellschaft) and filled into plastic cartridges (Ritter GmbH; volume ratio A:B=5:1) having inner diameters of 32.5 mm (component (A)) and 14 mm (component (B)).

### D) Determination of Bond Stress

In order to investigate the effects of the isosorbide diglycidyl methacrylate building block in comparison to the reference, the bond stresses of the two-component reactive resin systems were determined. In order to determine the bond stresses (load values) of the cured fixing compositions, M12 anchor threaded rods were inserted into boreholes in C20/25 concrete having a diameter of 14 mm and a borehole depth of 72 mm, which boreholes were filled with the reaction resin component compositions. The bond stresses were determined by centric extension of the anchor threaded rods. In each case, five anchor threaded rods were placed and after 24 hours of storage, the bond stress was determined. The fixing compositions were ejected out of the cartridges via a static mixer (HIT-RE-M mixer; Hilti Aktiengesellschaft) and injected into the boreholes. The following borehole conditions were set to determine the bond stress: the borehole was hammer-drilled in dry concrete and made dust-free by cleaning. The mortar was set and cured at room temperature. The storage and removal took place either at room temperature or at 80° C. Table 3 shows the results of these measurements. The composite stresses shown are average values from five measurements.

TABLE 3
Bond stresses of the reactive resin systems

| Reactive resin | Bond stress (20° C.) | Bond stress (80° C.) |
|---|---|---|
| system | [N/mm²] | [N/mm²] |
| C7 | 31.4 | 22.2 |
| C8 | 27.5 | 17.8 |

Even if the bond stresses of the reactive resin system C8 according to the invention are lower at both measurement temperatures than with reference C7, these load values are of a magnitude comparable to current market products (e.g. HILTI HIT HY-100), which proves the usability of the isosorbide building block.

### BRIEF DESCRIPTION OF THE DRAWINGS

FIG. 1 is a schematic representation of the evaluation of temperature-time curves

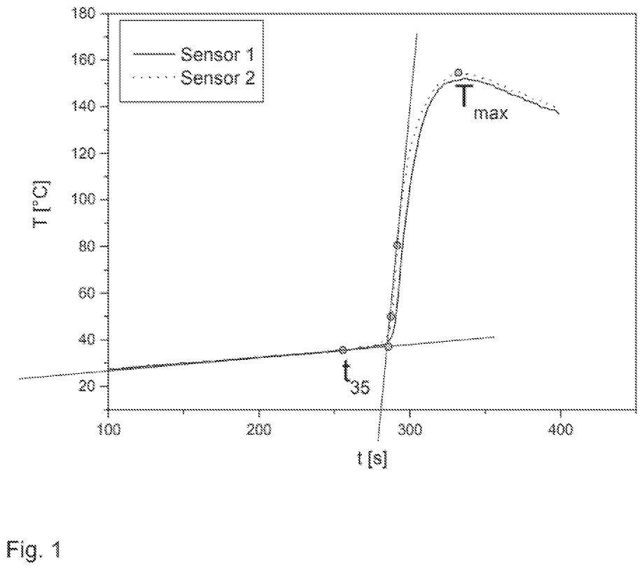

FIG. 2 shows the temperature-time curves measured in Example B

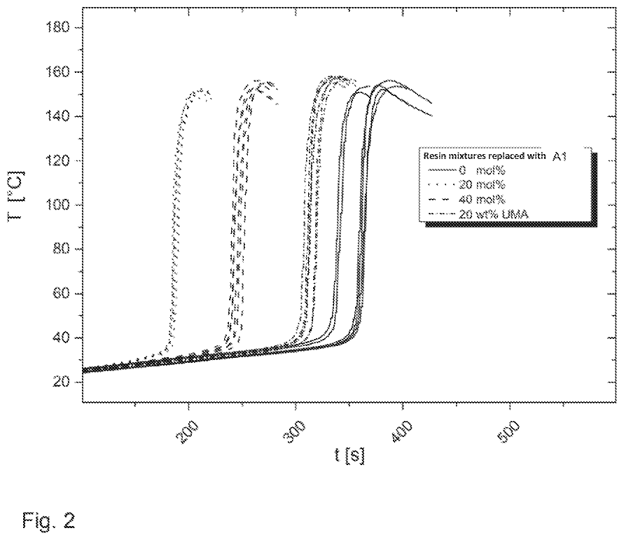

1. A reactive resin, comprising:
at least one dianhydrohexitol compound of formula (I), 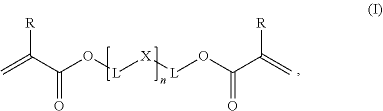
in which R represents a hydrogen atom or a methyl group,
X represents a dianhydrohexitol,
L represents, independently of one another, a bridging C₁-C₈ alkylene group, which may be unsubstituted or hydroxy-substituted, and n may be 1 to 5.

2. The reactive resin according to claim 1, wherein X is selected from the group consisting of isosorbide, isomannide, and isoidide.

3. The reactive according to claim 1, wherein X represents isosorbide.

4. The reactive resin according to claim 1, wherein the at least one dianhydrohexitol compound is an isosorbide compound of formula (Ib), 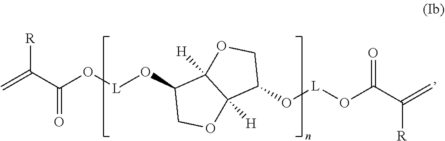
in which R represents a hydrogen atom or a methyl group.

5. The reactive resin according to claim 1, wherein L represents, independently of one another, a bridging C₃-C₅ alkylene group which is hydroxy-substituted.

6. The reactive resin according to claim 1, wherein L represents

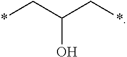

7. The reactive resin according to claim 1, comprising:
up to 70 wt. % of the at least one dianhydrohexitol compound of formula (I), based on a total weight of the reactive resin.

8. A method for chemical fastening, comprising:
applying the reactive resin according to claim 1 to an anchoring agent in a borehole.

9. A reactive resin cotrrponent, comprising:
the reactive resin according to claim 1; and
an inorganic and/or organic aggregate.

10. The reactive resin component according to claim 9, comprising the inorganic aggregate,. wherein the inorganic aggregate is selected from the group consisting of quartz, glass, corundum, porcelain, earthenware, light spar, baryte, gypsum, talc, chalk, and mixtures thereof, and wherein the inorganic aggregate is present in form of sand, flour, or molded bodies.

11. The reactive resin component according to claim 9, wherein the reactive resin is contained in an amount of from 10 to 60 wt. %, based on a total weight of the reactive resin component.

12. A two-component system, comprising:
the reactive resin component according to claim 9; and a hardener component.

13. The two-component system according to claim 12, wherein the hardener component comprises:
a radical initiator as a curing agent.

14. A method for chemical fastening, comprising:
applying a two-component system according to claim 12 to an anchoring agent in a borehole.

15. The method according to claim 8, wherein the anchoring agent is made of steel or iron.

16. The method according to claim 8, wherein the borehole is in a mineral or metal substrate.

17. The method according to claim 16, wherein the mineral or metal substrate is selected from the group consisting of concrete, aerated concrete, brickwork, limestone, sandstone, natural stone, glass, steel, and combinations thereof.
